(19) United States
(12) Patent Application Publication
(10) Pub. No.: US 2009/0198751 A1
(43) Pub. Date: Aug. 6, 2009

(54) METHOD AND APPARATUS FOR CONTROLLING FUNCTIONALITIES OF COMPUTER SYSTEM

(75) Inventors: Peng-Yu Chu, Taipei City (TW); Yu-Sung Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/061,655

(22) Filed: Apr. 3, 2008

(30) Foreign Application Priority Data
Jan. 31, 2008 (TW) 97103765

(51) Int. Cl. G06F 3/00

(52) U.S. Cl. 708/142

(57) ABSTRACT

A method and an apparatus for controlling functionalities of a computer system are provided. The apparatus comprises a key, a serial input unit, and a processing unit. The key is used for enabling an adjustment function of a computer system. The serial input unit is used for generating an adjustment signal for modifying a parameter corresponding to the adjustment function. The adjustment signal is omni-directional and continuously variable. The processing unit connected to the key and the serial input unit is used for modifying the parameter according to the adjustment signal so as to execute the adjustment function when the adjustment function is enabled. As a result, a more intuitive way to control the computer system is provided so as to increase the convenience of using the computer system.

### CROSS-REFERENCE TO RELATED APPLICATION

This application claims the priority benefit of Taiwan application serial no. 97103765, filed on Jan. 31, 2008. The entirety of the above-mentioned patent application is hereby incorporated by reference herein and made a part of this specification.

### BACKGROUND OF THE INVENTION

1. Field of the Invention

The present invention relates to a method and an apparatus for controlling functionalities of a computer system, and more particularly, to a method and an apparatus for controlling functionalities of a computer system by using a combination of various input devices.

2. Description of Related Art

In an architecture of a computer system, an input device is used to receive external information, such that the computer system can operate according to the received information. In other words, the user can control the computer system to execute different functions by operating the input devices. Currently, most common input devices are the keyboard and mouse. The user can use the keyboard to input a character or use the mouse to choose a file. In a notebook computer, aside from the keyboard, a touch pad is often included to take over the mouse. All the input devices, such as the keyboard, mouse, or the touch pad, enable the user to communicate with the computer system.

There are many kinds of input devices in the market. However, functionalities of the computer system controllable by each single input device are rather limited. For instance, when the user operates the mouse or touch pad, it only causes the cursor to be moved or the file to be chosen in the computer system. And the main function of the keyboard is to input characters. In addition to the character input function, current keyboards can support some special hotkey function to facilitate the user operating the computer system. Most common hotkey function is to switch windows of application programs by pressing the Alt and Tab keys. However, this operation manner only supports single directional switch. That is to say, when the user desires to switch back to a previous window, multiple repeat key pressing operations are required. Apparently, this operation manner is inconvenient and not intuitive to the user.

In addition to the hotkeys for switching windows, the user can simultaneously press the Fn key and upward or downward key to adjust settings (e.g., sound volume) of some special apparatus. However, each time when the user presses the upward or downward key, the amount of adjustment is preset and fixed. In other words, this operation manner does not allow the user to perform micro-adjustment to the apparatus, which inevitably affects the user's feel.

### SUMMARY OF THE INVENTION

Accordingly, the present invention is directed to an apparatus for controlling functionalities of a computer system that allows the user to operate the computer system using two different input devices so as to increase the flexibility in operation.

The present invention is also directed to a method for controlling functionalities of a computer system that increases the convenience in controlling the computer system functions by using a combination of different input devices.

The present invention provides an apparatus for controlling functionalities of a computer system, which includes a key, a serial input unit, and a processing unit. The key is used to enable an adjustment function of a computer system. The serial input unit is used to generate an omni-directional and continuously variable adjustment signal to modify a parameter corresponding to the adjustment function. The processing unit is coupled to the key and the serial input unit for modifying the parameter to thereby execute the adjustment function according to the adjustment signal when the adjustment function is enabled.

According to one embodiment of the present invention, the key comprises one of all keys on a keyboard of the computer system.

According to one embodiment of the present invention, the processing unit further comprises an adjustment function setting module for setting correlation between the one of all keys on the keyboard and the adjustment function. The processing unit determines whether or not the key is used to enable the adjustment function according to the correlation.

According to one embodiment of the present invention, the serial input unit comprises a knob. The processing unit modifies the parameter and hence executes the adjustment function according to the adjustment signal generated by the knob in response to being rotated at a rotating angle relative to an initial position in a rotating direction.

According to one embodiment of the present invention, the serial input unit comprises a touch pad. The processing unit modifies the parameter and hence executes the adjustment function according to a displacement of the adjustment signal the touch pad generates by being operated with an input tool.

According to one embodiment of the present invention, the adjustment function comprises switching windows of all application programs run in the computer system, adjusting a screen brightness of the computer system, adjusting a fan speed, and adjusting an apparatus that is variable in size or intensity.

In another aspect, the present invention provides a method for controlling functionalities of a computer system. First, an operation of a key is received to enable an adjustment function of a computer system. Then, an adjustment signal generated by a serial input unit is received. The adjustment signal is omni-directional and continuously variable. Finally, a parameter corresponding to the adjustment function is modified according to the adjustment signal so as to execute the adjustment function.

According to one embodiment of the present invention, the key may be one of all keys on a keyboard of the computer system.

According to one embodiment of the present invention, the method further comprises setting correlation between the one of the keys on the keyboard and the adjustment function. The act of receiving the operation of the key to enable the adjustment function comprises determining whether or not the key is used to enable the adjustment function according to the correlation.

According to one embodiment of the present invention, the serial input unit comprises a knob, and the act of modifying the parameter according to the adjustment signal so as to execute the adjustment function comprises modifying the parameter and executing the adjustment function according to the adjustment signal generated by the knob in response to being rotated at a rotating angle relative to an initial position in a rotating direction.

According to one embodiment of the present invention, the serial input unit comprises a touch pad, and the act of modifying the parameter according to the adjustment signal so as to execute the adjustment function comprises modifying the parameter and executing the adjustment function according to a displacement of the adjustment signal generated by the touch pad in response to being operated with an input tool.

According to one embodiment of the present invention, the adjustment function comprises switching windows of all application programs run in the computer system, adjusting a screen brightness of the computer system, adjusting a fan speed, and adjusting an apparatus that is variable in size or intensity.

The present invention uses a combination of key and serial input unit to control the computer system. With the characteristics of the serial input unit, the present invention provides the user with a more intuitive operation manner, thereby increasing the convenience in controlling the computer system.

In order to make the aforementioned and other features and advantages of the present invention more comprehensible, embodiments accompanied with figures are described in detail below.

### BRIEF DESCRIPTION OF THE DRAWINGS

FIG. 1 is a block diagram of an apparatus for controlling functionalities of a computer system according to one embodiment of the present invention.

FIG. 2 is a flow chart of a method for controlling functionalities of a computer system according to one embodiment of the present invention.

FIG. 3 is a flow chart of a method for controlling functionalities of a computer system according to another embodiment of the present invention.

FIG. 4 is a flow chart of a method for controlling functionalities of a computer system according to still another embodiment of the present invention.

### DESCRIPTION OF THE EMBODIMENTS

Under the current computer system architecture, although input signals from various input devices can be received, there is no mechanism to control the computer system in combination with these input signals. If a method is provided to control the computer system in combination with these input signals, this method certainly will facilitate the user operating the computer. The present invention is thus achieved based on this concept, which provides an apparatus and a method for controlling functionalities of a computer system. The present invention will now be described more in detail hereinafter with reference to the accompanying drawings, in which preferred embodiments of the invention are shown.

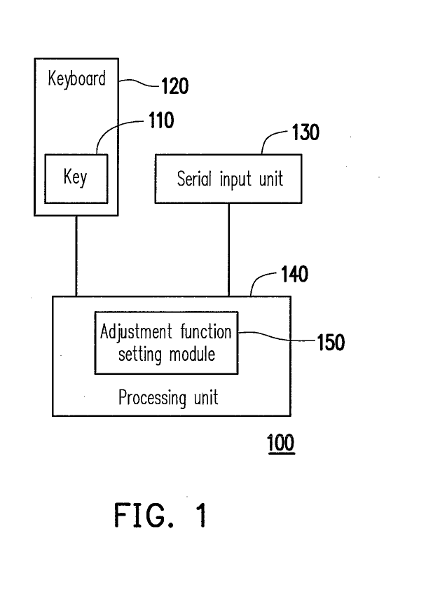

FIG. 1 illustrates a block diagram of an apparatus for controlling functionalities of a computer system according to one embodiment of the present invention. Referring to FIG. 1, in the present embodiment, the control apparatus 100 for controlling the functionalities of the computer system includes a key 110, a serial input unit 130, a processing unit 140, and an adjustment function setting module 150 adapted for controlling various adjustment functions of the computer system (not shown).

The key 110 is, for example, an arbitrary key on a keyboard 120 of the computer system, for enabling specific adjustment function of the computer system. The serial input unit 130 is used to generate an omni-directional and continuously variable adjustment signal to modify a parameter corresponding to the adjustment function. The processing unit 140 is connected to both the key 110 and the serial input unit 130, for modifying the parameter according to the adjustment signal so as to execute the adjustment function when the adjustment function is enabled. In the present embodiment, the processing unit 140 includes an adjustment function setting module 150 for setting the correlation between the key 110 and the adjustment function. In other words, the user can use the adjustment function setting module 150 to associate the keys on the keyboard 120 to different adjustment functions.

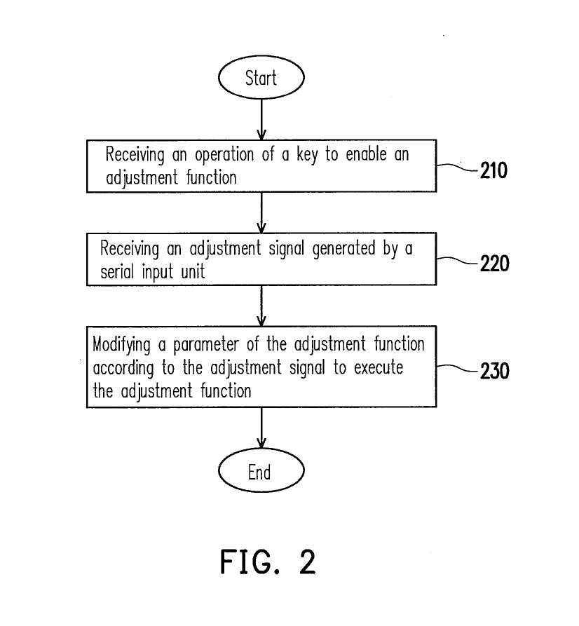

Operation of the apparatus 100 for controlling the computer system functionalities will be further described hereinafter in accordance with another embodiment. FIG. 2 illustrates a flow chart of a method for controlling the computer system functionalities according to one embodiment of the present invention.

Referring to FIGS. 1 and 2, first, before using the control apparatus 100 to execute the adjustment function of the computer system, the user can use the adjustment function setting module 150 to set the correlation between the various keys on the keyboard 120 and various adjustment functions of the computer system. For example, the user can set the function of the function key (Fn key) of the keyboard 120 as switching windows of application program, or set the function of Windows key as adjusting screen brightness of the computer system.

After setting of the correlation between the keys and the adjustment functions is completed, as shown in step 210, operation of the key 110 is received to enable one of the adjustment functions of the computer system. In the present embodiment, the processing unit 140 first determines, according to the established correlation, whether or not the key being currently operated is used to enable one adjustment function, such that it is determined whether the key being currently operated is a common key or a particular key that has been associated to one specific adjustment function.

Next, in step 210, an adjustment signal generated by the serial input unit 130 is received, and according to the adjustment signal, the parameter corresponding to the adjustment function is modified to execute the adjustment function in step 230. The adjustment function includes switching windows of all currently running application programs, adjusting screen brightness of the computer system, adjusting fan speed of the computer system, or adjusting those devices in the computer system that are variable in size or intensity.

In the present embodiment, the serial input unit can generate omni-directional and continuously variable adjustment signals. Therefore, the computer system can be versatilely controlled according to the adjustment signals.

For the purpose of illustrating an embodiment of the present invention, it is assumed that the serial input unit 130 is a knob (e.g., a volume adjustment knob), and pressing of the key 110 (e.g., Windows key) will enable the function of switching application program windows. As such, in the present embodiment, the control apparatus 100 can switch the windows of all currently running application programs upon the user operating the key 110 and the knob.

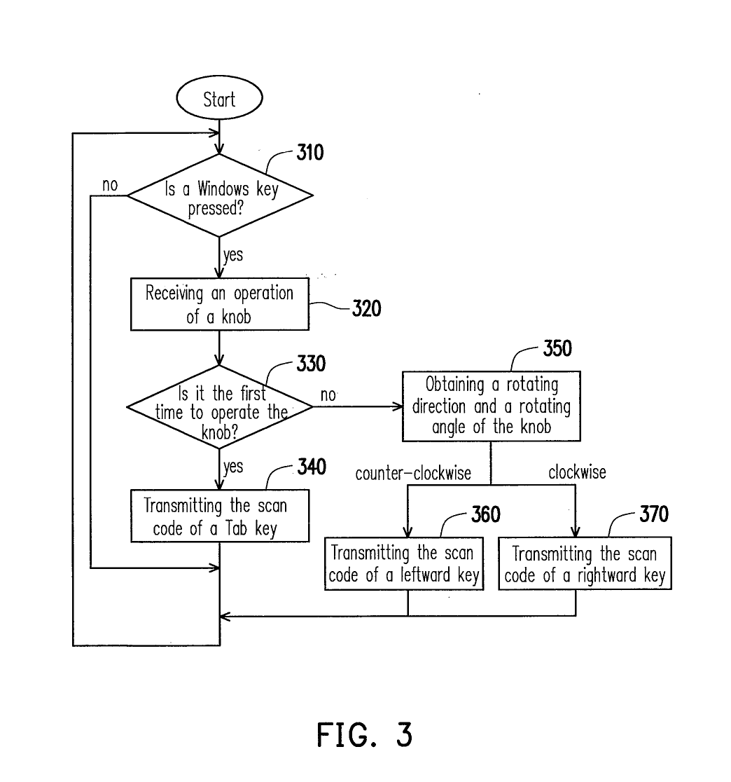

Referring to FIG. 3, when the input signal generated by pressing the key 110 is received, as shown in step 310, the processing unit 140 first determines whether or not the key being pressed is the Windows key so as to determine whether to enable the adjustment function corresponding to the windows key (i.e., the function of switching application program windows).

If the key pressed by the user is the Windows key, then in step 320, the operation of the knob is received. In this step, rotating direction and rotating angle of the knob rotated from an initial position are first detected, and adjustment signals corresponding to the rotating direction and rotating angle are transmitted to the processing unit 140.

Then as shown in step 330, it is determined whether it is the first time for the user to operate the knob. If it is determined that it is the first time for the user to operate the knob, it means that the function of switching application program windows has not been enabled. Therefore, in step 340, the processing unit 140 (e.g., embedded controller such as the keyboard controller) sends out the scan code of the Tab key. As such, the operation system of the computer system can receive the scan codes of both the Windows key and the Tab key. In the case of a Windows Vista system being run by the computer system, all currently opened application program windows will be presented on the screen in a three-dimensional manner allowing the user to switch.

If, at step 330, it is determined that it is not the first time for the user to rotate the knob, it means the function of switching application program windows has been enabled. Therefore, as shown in step 350, the processing unit 140 obtains the rotating direction and rotating angle according to the adjustment signals, and modifies the parameter of the adjustment function of switching application program windows according to the rotating direction and the rotating angle so as to switch the windows. Specifically, if the user rotates the knob in a clockwise direction, the processing unit 140 will send out the scan codes of the Windows key and a rightward key, thereby switching the application program windows in a forward direction (step 470). Conversely, if the user rotates the knob in a counter-clockwise direction, the processing unit 140 will send out the scan codes of the Windows key and a leftward key, thereby switching the application program windows in a reverse direction (step 360). As such, by pressing the Windows key and rotating the knob, the user can freely switch the application program windows in either the forward or the reverse direction, thus eliminating the limitation on switching directions. To the user, the way of switching operation by rotating the knob is not only very intuitive, but also very convenience in the case it is desired to switch back to a previous window.

After the application program windows have been switched, the present embodiment will return to step 310. If the user presses the Windows key and rotates the knob again, the processing unit 140 will again switch the application program windows according to the rotating direction and rotating angle.

Although in the above embodiment all running application program windows are switched by pressing the key in combination with rotating the knob, but this should not be regarded as limiting. Rather, the combination of these two input devices may also be used to control other adjustment function of the computer system. For instance, if the Windows key corresponds to the function of adjusting the fan speed, upon the user pressing the Windows key and rotating the knob in a counter-clockwise direction, the processing unit 140 will reduce the fan speed according to the rotating angle; upon the user pressing the Windows key and rotating the knob in a clockwise direction, the processing unit 140 will increase the fan speed correspondingly.

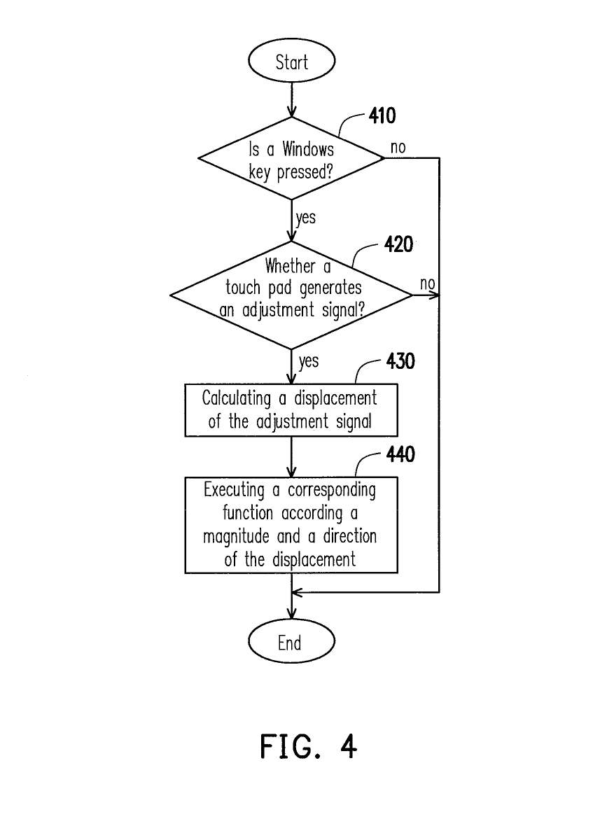

In another embodiment, it is assumed that the serial input unit 130 is a touch pad, and the Windows key corresponds to the function of adjusting screen brightness of the computer system. In this embodiment, the screen brightness is adjusted in response to the user pressing the Windows key and operating the touch pad. Referring to FIG. 4, when the key 110 is pressed, as shown in step 410, it is determined whether the key 110 being pressed is the Windows key and hence determined whether to enable the function of adjusting screen brightness of the computer system.

If the key 110 pressed by the user is the Windows key, then in step 420, it is determined that whether the touch pad generates an adjustment signal in response to the user's operation with an input tool. If the touch pad generates an adjustment signal, then as shown in step 430, displacement of the adjustment signal is calculated according to initial and terminating positions of the adjustment signal. Then, in step 440, the parameter of the screen brightness is modified according to the magnitude and direction of the displacement, thereby executing the screen brightness adjustment function. For example, it is assumed that rightward direction of the adjustment signal means the screen brightness is to be increased, and leftward direction of the adjustment signal means the screen brightness is to be reduced. The amount of brightness adjustment varies with the displacement of the adjustment signal, i.e., bigger displacement produces greater amount of brightness adjustment, while smaller displacement produces less amount of brightness adjustment. As such, the present embodiment enables the user to perform micro-adjustment to the screen brightness based on the user's habit and needs.

In the above exemplary embodiment, the adjustment function executed in response to the operation to the key and touch pad is to adjust the screen brightness. However, the present method is applicable to adjust any settings of a computer system that are variable in size or intensity and, therefore, the above embodiment should not be regarded as limiting.

In summary, the apparatus and method for controlling computer system functionalities of the present invention at least has the following advantages:

1. The present invention provides a more intuitive operation method and hence increases the convenience in adjusting the computer system functions by using a combination of multiple input devices.

2. Any function of a computer system that is variable in size or intensity can be adjusted through this method, thus increasing the flexibility of computer system control.

3. When executing the corresponding function adjustment according to the input signal generated by the input device, the adjustment is no longer limited by the single direction of the input signal and the amount of adjustment, thereby making the adjustment more suitable for user demand.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for controlling functionalities of a computer system, comprising:
a key for enabling an adjustment function of a computer system;
a serial input unit for generating an omni-directional and continuously variable adjustment signal to modify a parameter corresponding to the adjustment function; and
a processing unit coupled to the key and the serial input unit for modifying the parameter to thereby execute the adjustment function according to the adjustment signal when the adjustment function is enabled.

2. The apparatus for controlling functionalities of a computer system in accordance with claim 1, wherein the key comprises one of keys on a keyboard of the computer system.

3. The apparatus for controlling functionalities of a computer system in accordance with claim 2, wherein the processing unit further comprises an adjustment function setting module for setting a correlation between the one of the keys on the keyboard and the adjustment function.

4. The apparatus for controlling functionalities of a computer system in accordance with claim 3, wherein the processing unit determines whether or not the key is used to enable the adjustment function according to the correlation.

5. The apparatus for controlling functionalities of a computer system in accordance with claim 1, wherein the serial input unit comprises a knob, and the processing unit modifies the parameter and hence executes the adjustment function according to the adjustment signal the knob generates by being rotated a rotating angle from an initial position in a rotating direction.

6. The apparatus for controlling functionalities of a computer system in accordance with claim 1, wherein the serial input unit comprises a touch pad, and the processing unit modifies the parameter and hence executes the adjustment function according to a displacement of the adjustment signal the touch-pad generates by being operated with an input tool.

7. The apparatus for controlling functionalities of a computer system in accordance with claim 1, wherein the adjustment function comprises switching windows of all application programs run in the computer system.

8. The apparatus for controlling functionalities of a computer system in accordance with claim 1, wherein the adjustment function comprises adjusting a screen brightness of the computer system.

9. The apparatus for controlling functionalities of a computer system in accordance with claim 1, wherein the adjustment function comprises adjusting a fan speed of the computer system.

10. The apparatus for controlling functionalities of a computer system in accordance with claim 1, wherein the adjustment function comprises adjusting an apparatus of the computer system that is variable in size or intensity.

11. The apparatus for controlling functionalities of a computer system in accordance with claim 1, wherein the processing unit comprises an embedded controller.

12. A method for controlling functionalities adapted for a computer system, the method comprising:
receiving an operation of a key to enable an adjustment function of a computer system;
receiving an adjustment signal generated by a serial input unit, the adjustment signal being omni-directional and continuously variable; and
modifying a parameter corresponding to the adjustment function according to the adjustment signal so as to execute the adjustment function.

13. The method for controlling functionalities in accordance with claim 12, comprising:
providing a keyboard, located on the computer system wherein the keyboard includes a plurality of keys;
setting a correlation between the one of the keys on the keyboard and the adjustment function.

14. The method for controlling functionalities in accordance with claim 13, wherein the step of receiving the operation of the key to enable the adjustment function comprises determining whether or not the key is used to enable the adjustment function according to the correlation.

15. The method for controlling functionalities in accordance with claim 12, wherein the serial input unit comprises a knob, and the step of modifying the parameter according to the adjustment signal so as to execute the adjustment function comprises modifying the parameter and executing the adjustment function according to the adjustment signal the knob generates by being rotated a rotating angle from an initial position in a rotating direction.

16. The method for controlling functionalities in accordance with claim 12, wherein the serial input unit comprises a touch pad, and the step of modifying the parameter according to the adjustment signal so as to execute the adjustment function comprises modifying the parameter and executing the adjustment function according to a displacement of the adjustment signal the touch pad generates by being operated with an input tool.

17. The method for controlling functionalities in accordance with claim 12, wherein the adjustment function comprises switching windows of all application programs run in the computer system.

18. The method for controlling functionalities in accordance with claim 12, wherein the adjustment function comprises adjusting a screen brightness of the computer system.

19. The method for controlling functionalities in accordance with claim 12, wherein the adjustment function comprises adjusting a fan speed of the computer system.

20. The method for controlling functionalities in accordance with claim 12, wherein the adjustment function comprises adjusting an apparatus of the computer system that is variable in size or intensity.
